(19) United States
(12) Patent Application Publication
(10) Pub. No.: US 2012/0073402 A1
(43) Pub. Date: Mar. 29, 2012

(54) BICYCLE PEDAL MOUNTING STRUCTURE

(75) Inventor: Chao Chien TSENG, Taichung County (TW)

(73) Assignee: Mr. Wen Teng Lin, Taichung County (TW)

(21) Appl. No.: 12/890,692

(22) Filed: Sep. 26, 2010

(51) Int. Cl. G05G 1/46; G05G 1/483

(52) U.S. Cl. 74/563; 74/560

(57) ABSTRACT

A bicycle pedal mounting structure includes a pedal assembly and a retaining sleeve connected to the pedal assembly. The retaining sleeve has a positioning groove defined therein. The pedal assembly includes a pedal and a spindle pivotally mounted on the pedal. A pivot sleeve is sleeved on the spindle and has a limiting flange formed thereon. The pivot sleeve has a receiving groove and at least two bores defined therein. A positioning ball is received in each bore. A slidable sleeve has a through hole defined therein for sleeving on the pivot sleeve. The slidable sleeve has an annular recess and an inserted recess defined therein. The slidable sleeve has a limiting flange formed thereon. A first spring is compressively sleeved on the pivot sleeve and abutting against between the limiting flange of the pivot sleeve and the limiting flange of the slidable sleeve.

### BACKGROUND OF THE INVENTION

1. Field of the Invention

The present invention relates to a bicycle pedal mounting structure, and more particularly to a pedal mounting structure provided for quickly detaching the pedal from a crank and easily mounting the pedal to the crank.

2. Description of Related Art

Nowadays, a conventional bicycle pedal device in accordance with the prior art comprises a pedal provided for being stepped by a rider. The pedal is pivotally connected with one end of a spindle. The other end of the spindle is screwedly connected with a bicycle crank. However, it is not quick and easy to disassemble/assemble the pedal with the crank. Moreover, after the pedal is detached from the bicycle, there is no storage space for placing the pedal, such that the pedal is easily lost.

The present invention has arisen to mitigate and/or obviate the disadvantages of the conventional bicycle pedal device.

### SUMMARY OF THE INVENTION

To solve the problems that the conventional bicycle pedal device is not easy and quick to be operated and the detached pedal is easily lost due to no storage space, the main objective of the present invention is to provide an improved bicycle pedal mounting structure for easily and quickly assembling/disassembling a pedal assembly with a crank.

The secondary objective of the present invention is to provide a storage effect for storing the pedal assembly.

To achieve the objectives, the bicycle pedal mounting structure in accordance with the present invention comprises a pedal assembly and a retaining sleeve mounted on the pedal assembly. The pedal assembly includes a pedal for adapting to be stepped on by a rider and a spindle having a first end pivotally mounted on the pedal, such that the spindle is able to pivotally rotate relative to the pedal. The spindle has a connecting portion axially formed on and protruding from a second end thereof opposite to the first end. The connecting portion of the spindle is hexagonal-shaped. The connecting portion has a through bore radially defined therein and formed two openings on an outer periphery thereof. An abutting ball is received in the through bore and movably engaged with each opening which has a diameter less than an outer diameter of the abutting ball. A fastener is received in the through bore and fixedly threaded in the other opening. A second spring is compressively received in the through bore and has two ends respectively abutting against the abutting ball and the fastener.

A pivot sleeve is coaxially and fixedly sleeved on the second end of the spindle. The pivot sleeve has a limiting flange annularly formed on an outer periphery of a first end thereof. The pivot sleeve has a receiving groove annularly defined in an inner periphery of a second end thereof opposite to the first end. The receiving groove has an inner diameter greater than an outer diameter of the connecting portion for corresponding to a shape of the connecting portion. The pivot sleeve has at least two bores radially defined in the second end and extending therethrough for communicating with the receiving groove. A positioning ball is movably received in each of the at least two bores.

A slidable sleeve has a through hole axially defined therein and is coaxially slidably sleeved on the pivot sleeve. The slidable sleeve has an annular recess defined in an inner periphery of the through hole for selectively engaging with the positioning balls. The slidable sleeve has an inserted recess defined in the inner periphery of the through hole thereof. The slidable sleeve having a limiting flange annularly formed on the inner periphery of the through hole and located between the annular recess and the inserted recess. The slidable sleeve has two anti-slip surfaces annularly disposed on an outer periphery thereof and has a hollow portion annularly formed on the middle of the outer periphery thereof. The hollow portion is located between the two anti-slip surfaces.

A first spring is coaxially sleeved on the pivot sleeve and compressively received in the inserted recess of the slidable sleeve. The first spring has two ends respectively abutting against the limiting flange of the pivot sleeve and the limiting flange of the slidable sleeve.

Moreover, the retaining sleeve has a retaining hole axially defined therein for correspondingly receiving the connecting portion of the spindle. The retaining sleeve has a plurality of indents defined in an inner periphery of the retaining hole for selectively engaging with the abutting ball, such that the connecting portion is detachably and coaxially received in the retaining hole. A first end of the retaining sleeve has an outer diameter less than an inner diameter of the receiving groove of the pivot sleeve. The retaining sleeve has a positioning groove annularly defined in an outer periphery of the first end thereof for selectively engaging with the positioning balls. The retaining sleeve has a threaded portion annularly formed on an outer periphery of a second end thereof opposite to the first end for screwedly connecting with a crank. When the connecting portion of the spindle is detached from the first end of the retaining sleeve, the connecting portion of the spindle is able to be received in the second end of the retaining sleeve for storage.

The benefits and advantages of present invention are as follows:

First, the pedal assembly is easily and quickly detached from or assembled with the retaining sleeve because of the engagement of the positioning balls and the positioning groove.

Second, the connecting portion of the spindle is able to be received in the second end of the retaining sleeve and the abutting ball engages with any one of indents for positioning the spindle in place. Therefore, the pedal assembly is stored within the second end of retaining sleeve when the rider does not ride the bicycle.

Third, the hexagonal retaining hole correspondingly receives the hexagonal-shaped connecting portion, such that the connecting portion would not pivotally rotate relative to the retaining sleeve.

Fourth, the hexagonal retaining sleeve is easily assembled with the crank by operating a hexagonal wrench.

Fifth, the connecting portion is securely connected with the retaining sleeve by the engagement of the abutting ball and the indent for preventing the connecting portion from pivotally rotating and axially moving relative to the retaining sleeve.

Sixth, when a rider grips the slidable sleeve, the rider's fingers are able to press the hollow portion for easily moving the slidable sleeve, and the anti-slip surfaces provide a friction force for preventing slipping. And different patterns may be formed on the anti-slip surfaces.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a pedal assembly and a retaining sleeve of a bicycle pedal mounting structure in accordance with the present invention;

FIG. 2 is an exploded perspective view of the bicycle pedal mounting structure in accordance with the present invention;

FIG. 3 is a partial cross-sectional side view of the bicycle pedal mounting structure in accordance with the present invention;

FIGS. 4A-4C are operational cross-sectional side views of the bicycle pedal mounting structure in accordance with the present invention;

FIG. 5 is an assembled perspective view of the bicycle pedal mounting structure in accordance with the present invention as the retaining sleeve is connected to a crank; and

FIG. 6 is a partial cross-sectional side view of the bicycle pedal mounting structure in accordance with the present invention as the pedal assembly is stored in a second end of the retaining sleeve.

### DETAILED DESCRIPTION OF THE INVENTION

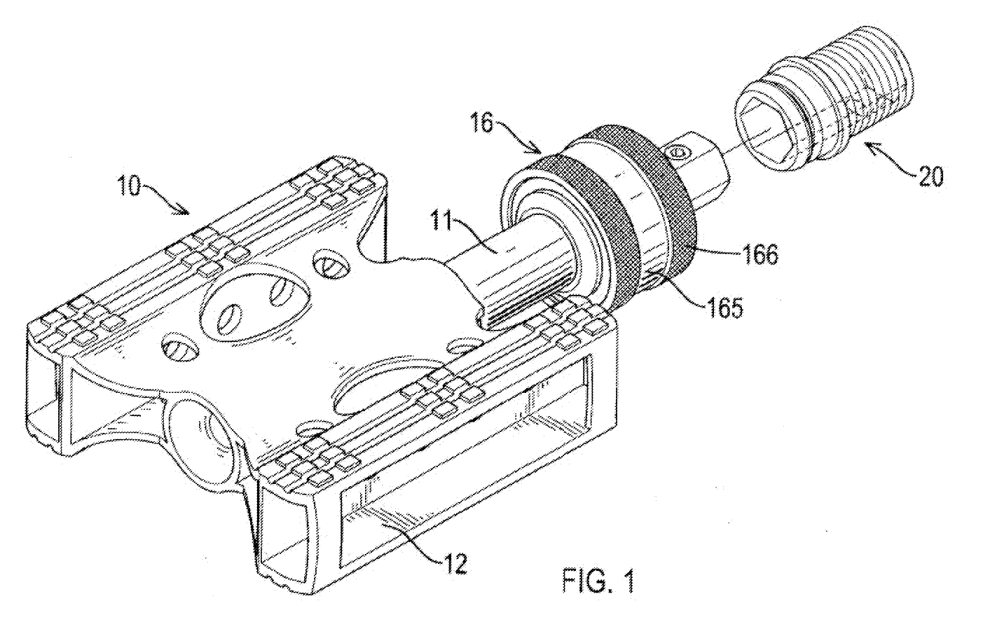

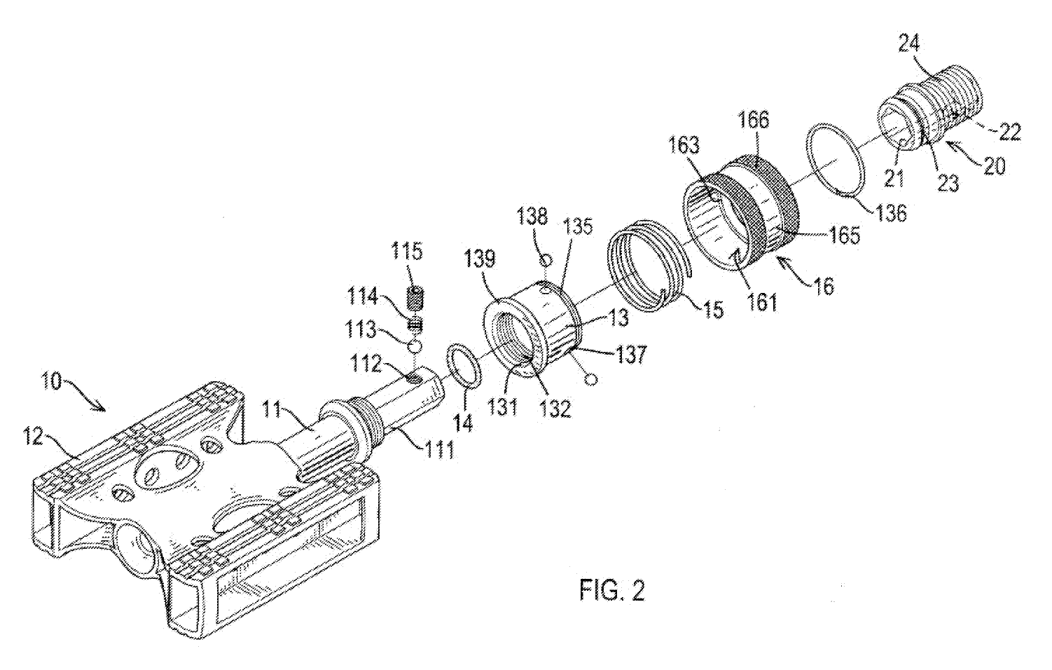

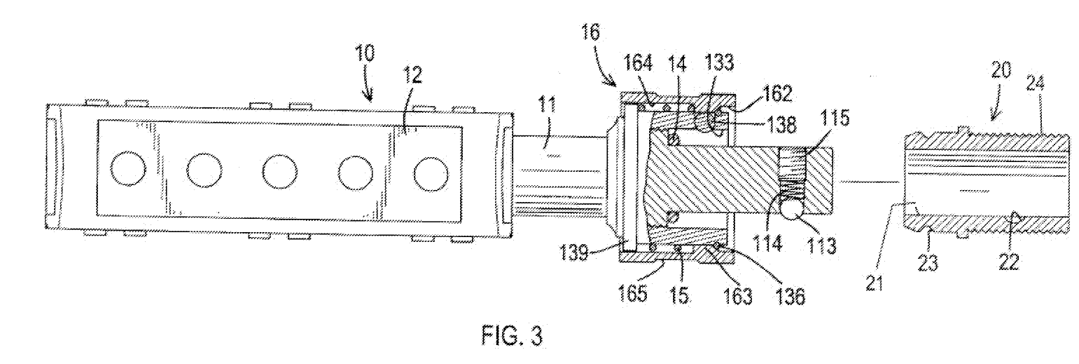

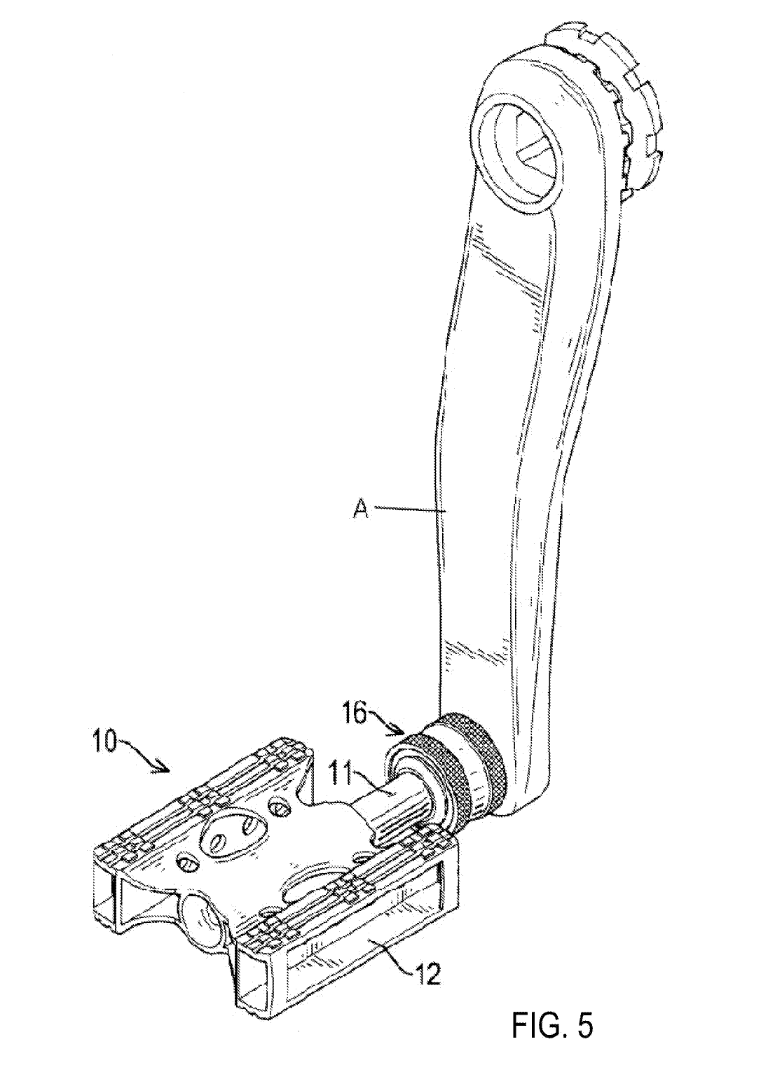

Referring to the drawings and initially to FIGS. 1-3 and 5, a bicycle pedal mounting structure in accordance with the present invention comprises a pedal assembly (10) and a retaining sleeve (20) detachably mounted on the pedal assembly (10). The pedal assembly (10) includes a pedal (12) for adapting to be stepped on by a rider and a spindle (11) having a first end pivotally mounted on the pedal (12), such that the spindle (11) is able to pivotally rotate relative to the pedal (12). The spindle (11) has a connecting portion (111) axially formed thereon and protruding from a second end thereof opposite to the first end. The connecting portion (111) of the spindle (11) is hexagonal-shaped. The connecting portion (111) has a through bore (112) radially defined therein and formed two openings (not numbered) on an outer periphery thereof. An abutting ball (113) is received in the through bore (112) and movably engaged with one opening which has a diameter less than an outer diameter of the abutting ball (113). A fastener (115) is received in the through bore (112) and fixedly threaded in the other opening of the through bore (112). A second spring (114) is compressively received in the through bore (112) and has two ends respectively abutting against the abutting ball (113) and the fastener (115), such that the abutting ball (113) is pressed outwardly by the second spring (114) and partially projects from the opening of the through bore (112).

A pivot sleeve (13) has a pivot hole (131) axially defined therein and extending therethrough. The pivot sleeve (13) has a threaded portion (132) annularly formed on an inner periphery of the pivot hole (131) and located at a first end thereof, such that the pivot sleeve (13) is coaxially sleeved on and fixedly screwed to the second end of the spindle (11). The pivot sleeve (13) is located between the pedal (12) and the connecting portion (111) of the spindle (11) and is close to the connecting portion (111). The pivot sleeve (13) has a receiving groove (133) annularly defined in the inner periphery of the pivot hole (131) and located at a second end thereof opposite to the first end. The receiving groove (133) has an inner diameter greater than an outer diameter of the connecting portion (111), wherein the receiving groove (133) has a location corresponding to the connecting portion (111) of the spindle (11). An oil-seal washer (14) is received in the receiving groove (133) and sleeved on the connecting portion (111).

Additionally, the pivot sleeve (13) has a plurality of bores (137) radially defined in the second end and extending therethrough. Each bore (137) forms an opening (not numbered) defined in the inner periphery of the receiving groove (133) and communicates with the receiving groove (133). A positioning ball (138) is movably received in each bore (137) and has a diameter greater than that of the opening of the bore (137), wherein each positioning ball (138) partially projects from the opening of the corresponding bore (137). The pivot sleeve (13) has an annular groove (135) defined in an outer periphery of the second end thereof. A positioning ring (136) is engaged with the annular groove (135). The pivot sleeve (13) has a limiting flange (139) annularly formed on an outer periphery of the first end thereof.

A slidable sleeve (16) has a through hole (161) axially defined therein and is coaxially slidably sleeved on the pivot sleeve (13). The slidable sleeve (16) is restricted by the positioning ring (136) to avoid detaching from the pivot sleeve (13). The slidable sleeve (16) has an annular recess (162) defined in an inner periphery of the through hole (161) for selectively engaging with the positioning balls (138). The annular recess (162) is located corresponding to the second end of the pivot sleeve (13). The slidable sleeve (16) has an inserted recess (164) defined in the inner periphery of the through hole (161) thereof. The slidable sleeve (16) has a limiting flange (163) annularly formed on the inner periphery of the through hole (161) and located between the annular recess (162) and the inserted recess (164) for selectively abutting against the positioning balls (138) in the bores (137). The slidable sleeve (16) has two anti-slip surfaces (166) annularly and parallelly disposed on an outer periphery thereof. And different patterns may be formed on the anti-slip surfaces (166) for providing a friction force. The slidable sleeve (16) has a hollow portion (165) annularly formed on the middle of the outer periphery thereof and located between the two anti-slip surfaces (166). When a rider grips the slidable sleeve (16), the rider's fingers are able to press the hollow portion (165) for easily moving the slidable sleeve (16), and the anti-slip surfaces (166) provide a friction force for preventing slipping.

A first spring (15) is coaxially sleeved on the pivot sleeve (13) and compressively received in the inserted recess (164) of the slidable sleeve (16). The first spring (15) has two ends respectively abutting against the limiting flange (139) of the pivot sleeve (13) and the limiting flange (163) of the slidable sleeve (16).

Moreover, the retaining sleeve (20) has a retaining hole (21) axially defined therein for correspondingly receiving the connecting portion (111) of the spindle (11). The retaining sleeve (20) has a plurality of indents (22) spacedly defined in an inner periphery of the retaining hole (21) for selectively engaging with the abutting ball (113), wherein when the connecting portion (111) is coaxially inserted into the retaining hole (21), the abutting ball (113) is engaged with any one of the indents (22) for preventing the connecting portion (111) from pivotally rotating and axially moving relative to the retaining sleeve (20). A first end of the retaining sleeve (20) has an outer diameter less than an inner diameter of the receiving groove (133) of the pivot sleeve (13). The retaining sleeve (20) has a positioning groove (23) annularly defined in an outer periphery of the first end thereof for selectively engaging with the positioning balls (138). The retaining sleeve (20) has a threaded portion (24) annularly formed on an outer periphery of a second end thereof opposite to the first end for screwedly connecting with a crank (A). When the connecting portion (111) of the spindle (11) is detached from the first end of the retaining sleeve (20), the connecting portion (111) of the spindle (11) is able to be received in the second end of the retaining sleeve (20) for storage.

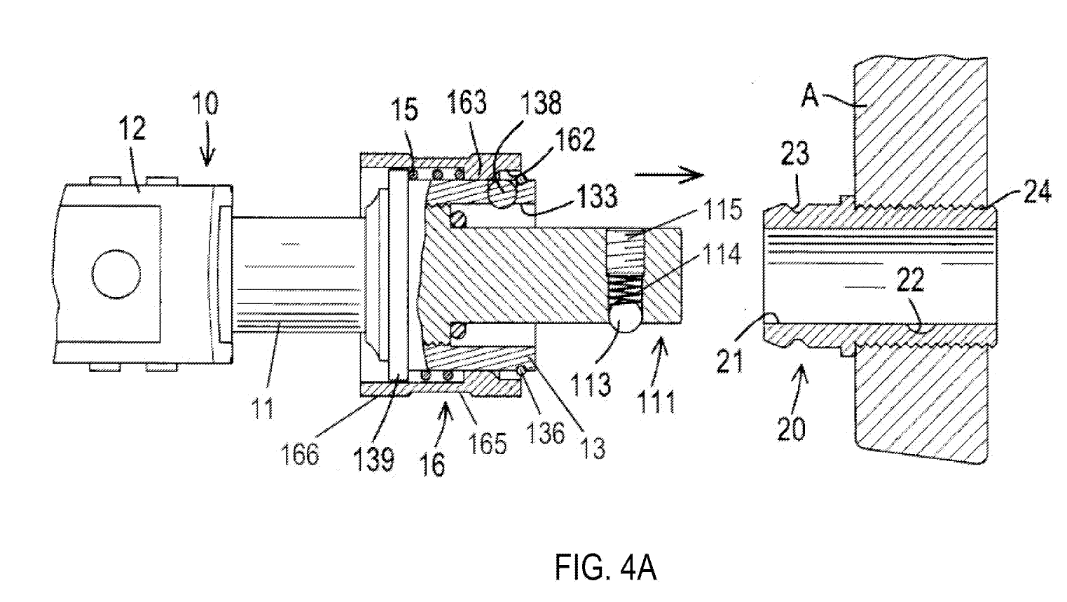

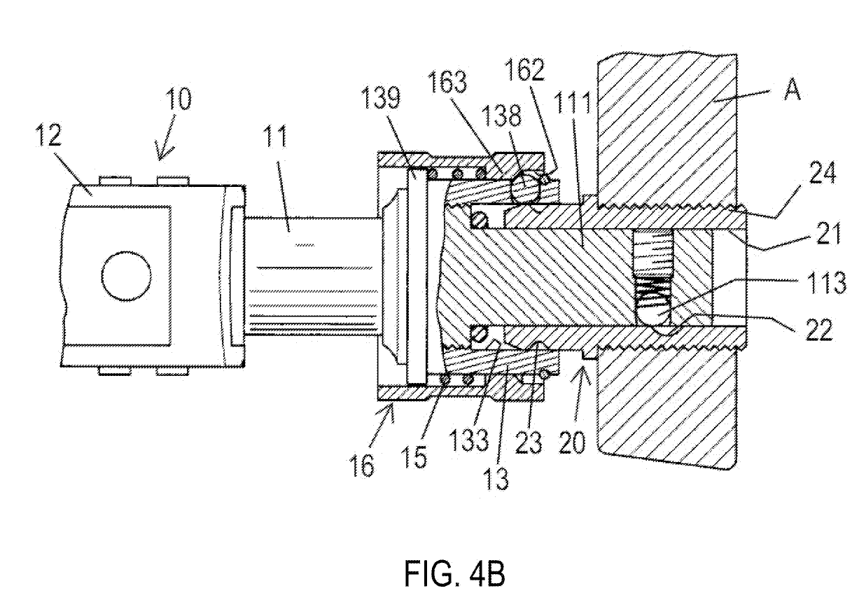

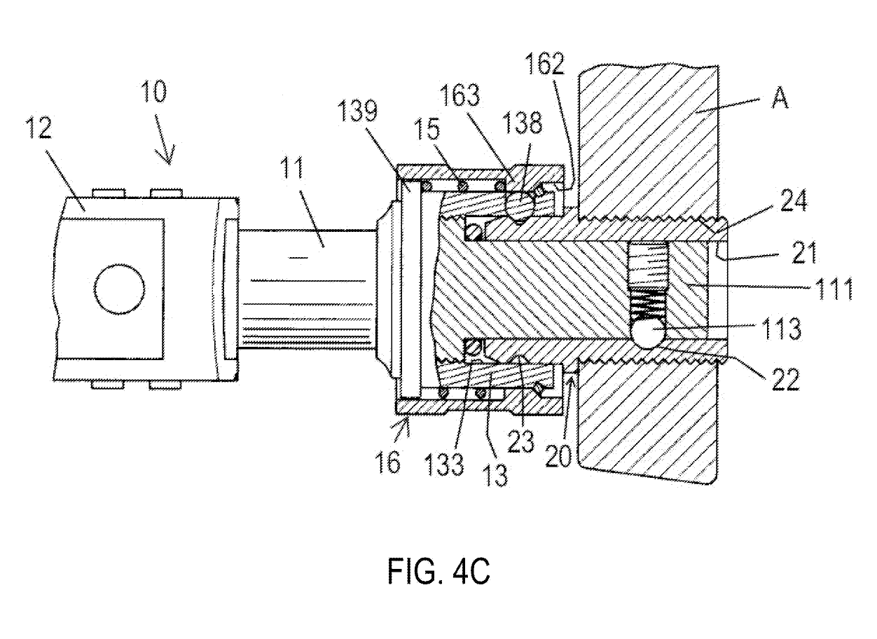

The operation of the bicycle pedal mounting structure in accordance with the present invention will be described in detailed below. As shown in FIGS. 4A-4C, the threaded portion (24) of the retaining sleeve (20) is screwedly connected with the crank (A). The pivot sleeve (13) is fixedly screwed to the second end of the spindle (11). The slidable sleeve (16) is sleeved on the pivot sleeve (13) and is in an initial position which the limiting flange (163) of the slidable sleeve (16) radially abuts against the positioning balls (138). First of all, the rider grips the slidable sleeve (16) and axially moves the slidable sleeve (16) toward the pedal (12). The limiting flange (163) of the slidable sleeve (16) moves toward the limiting flange (139) of the pivot sleeve (13) and compresses the first spring (15). The annular recess (162) simultaneously moves to engage with the positioning balls (138). Sequentially, the rider inserts the connecting portion (111) of the spindle (11) into the retaining hole (21) of the retaining sleeve (20). The first end of the retaining sleeve (20) is received in the receiving groove (133) of the pivot sleeve (13).

Followingly, the abutting ball (113) is engagedly positioned in any one of the indents (22). The first spring (15) provides a restoring force for pushing the slidable sleeve (16) back to the initial position. The limiting flange (163) of the slidable sleeve (16) is simultaneously moved by the first spring (15) to abut against the positioning balls (138) again, such that the positioning balls (138) are pressed by the limiting flange (163) to be engaged with the positioning groove (23). Therefore, the connecting portion (111) of the spindle (11) would not axially move relative to the retaining sleeve (20). And the hexagonal retaining hole (21) correspondingly receives the hexagonal-shaped connecting portion (111), such that the connecting portion (111) would not pivotally rotate relative to the retaining sleeve (20).

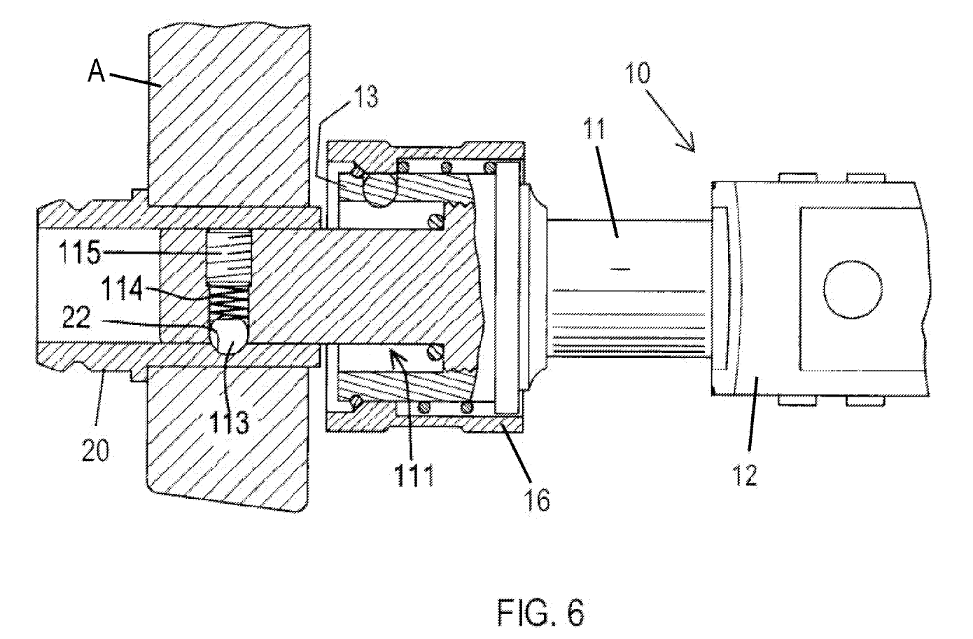

Accordingly, as shown in FIG. 6, when the pedal assembly (10) is detached from first end of the retaining sleeve (20), the connecting portion (111) of the spindle (11) is able to be inserted into the second end of the retaining sleeve (20) and the abutting ball (113) is engagedly positioned in any one of the indents (22), such that the pedal assembly (10) is stored in the second end of the retaining sleeve (20).

Although the invention has been explained in relation to its preferred embodiment, it is to be understood that many other possible modifications and variations can be made without departing from the spirit and scope of the invention as hereinafter claimed.

What is claimed is:

1. A bicycle pedal mounting structure comprising:
a pedal assembly comprising:
a pedal for adapting to be stepped on by a rider;
a spindle having a first end pivotally mounted on the pedal, such that the spindle is able to pivotally rotate relative to the pedal, the spindle having a connecting portion axially formed thereon and protruding from a second end thereof opposite to the first end, the connecting portion having a through bore radially defined therein and formed two openings on an outer periphery thereof, an abutting ball received in the through bore and movably engaged with one opening, the opening having a diameter less than an outer diameter of the abutting ball, a fastener received in the through bore and fixedly threaded in the other opening, a second spring compressively received in the through bore and having two ends respectively abutting against the abutting ball and the fastener;
a pivot sleeve coaxially and fixedly sleeved on the second end of the spindle, the pivot sleeve having a limiting flange annularly formed on an outer periphery of a first end thereof, the pivot sleeve having a receiving groove annularly defined in an inner periphery of a second end thereof opposite to the first end for corresponding to the connecting portion of the spindle, the connecting portion having an outer diameter less than an inner diameter of the receiving groove, the pivot sleeve having at least two bores radially defined in the second end and extending therethrough for communicating with the receiving groove, a positioning ball movably received in each of the at least two bores;
a slidable sleeve coaxially and slidably sleeved on the pivot sleeve, the slidable sleeve having a through hole axially defined therein and extending therethrough, the slidable sleeve having an annular recess defined in an inner periphery of the through hole for selectively engaging with the positioning balls, the slidable sleeve having an inserted recess defined in the inner periphery of the through hole thereof, the slidable sleeve having a limiting flange annularly formed on the inner periphery of the through hole and located between the annular recess and the inserted recess; and
a first spring coaxially sleeved on the pivot sleeve and compressively received in the inserted recess of the slidable sleeve, the first spring having two ends respectively abutting against the limiting flange of the pivot sleeve and the limiting flange of the slidable sleeve;
a retaining sleeve detachably and coaxially receiving the second end of the spindle, the retaining sleeve having a retaining hole axially defined therein for correspondingly receiving the connecting portion, the retaining sleeve having a plurality of indents spacedly defined in an inner periphery of the retaining hole for selectively engaging with the abutting ball, a first end of the retaining sleeve having an outer diameter less than the inner diameter of the receiving groove of the pivot sleeve, the retaining sleeve having a positioning groove annularly defined in an outer periphery of the first end thereof for selectively engaging with the positioning balls.

2. The bicycle pedal mounting structure as claimed in claim 1, wherein the connecting portion of the spindle is hexagonal-shaped.

3. The bicycle pedal mounting structure as claimed in claim 1, wherein the slidable sleeve has a hollow portion annularly formed on the middle of an outer periphery thereof.

4. The bicycle pedal mounting structure as claimed in claim 3, wherein the slidable sleeve has two anti-slip surfaces annularly disposed on the outer periphery thereof, the hollow portion located between the two anti-slip surfaces.

5. The bicycle pedal mounting structure as claimed in claim 1, wherein the retaining sleeve has a threaded portion annularly formed on an outer periphery of a second end thereof opposite to the first end.
